(19) United States
(12) Patent Application Publication
(10) Pub. No.: US 2010/0206355 A1
(43) Pub. Date: Aug. 19, 2010

(54) SELF GENERATING PHOTOVOLTAIC POWER UNIT

(75) Inventor: Ron Johnson, Katy, TX (US)

Correspondence Address: BRACEWELL & GIULIANI LLP, P.O. BOX 61389, HOUSTON, TX, 77208-1389, US

(73) Assignee: Infusion Solar Technologies, Houston, TX (US)

(21) Appl. No.: 12/370,815

(22) Filed: Feb. 13, 2009

(51) Int. Cl. H02N 6/00

(52) U.S. Cl. 136/246

(57) ABSTRACT

A photovolataic cell powered by artificial lights, wherein photovoltaic cell and artificial lights use a light guide to distribute light onto the photovoltaic cell while maintaining an overall compact shape.

### BACKGROUND

1. Field of the Invention

This disclosure relates in general to generating power with photovoltaic cells using artificial light.

2. Brief Description of Related Art

Photovoltaic (“PV”) cells produce electricity when exposed to light. PV cells are commonly used as solar cells, wherein the light is provided by the sun. A solar cell only produces electricity when exposed to sunlight and thus is less useful on overcast days and do not produce any electricity at night. Furthermore, a cluster or array of solar cells must be used to produce large quantities of electricity. An array of cells with solar exposure may take up considerable geographic space and may not be practical for use in a small space such as an urban area or in a vehicle. Therefore, it is desirable to have PV cells that do not require exposure to sunlight to produce power.

### BRIEF DESCRIPTION OF THE DRAWINGS

FIG. 1 is an illustration of an exemplary embodiment of a power unit, wherein the light guide is lifted away from the photovoltaic panel for illustrative purposes.

FIG. 2 is an illustration of an exemplary embodiment of a power unit.

FIG. 3 is a sectional view of the power unit of FIG. 2, taken along the 3-3 line.

FIG. 4 is a side view of an assembly comprising two photovoltaic panels and one light guide in an exemplary embodiment.

FIG. 5 is a diagram of a power unit and components in an exemplary embodiment.

FIG. 6 is a side view of multiple power units stacked together in an exemplary embodiment.

### DETAILED DESCRIPTION

In the drawings and description that follows, like parts are marked throughout the specification and drawings with the same reference numerals, respectively. The drawings are not necessarily to scale. Certain features of the invention may be shown exaggerated in scale or in somewhat schematic form and some details of conventional elements may not be shown in the interest of clarity and conciseness. The present invention is susceptible to embodiments of different forms. Specific embodiments are described in detail and are shown in the drawings, with the understanding that the present disclosure is to be considered an exemplification of the principles of the invention, and is not intended to limit the invention to that illustrated and described herein. It is to be fully recognized that the different teachings of the embodiments discussed below may be employed separately or in any suitable combination to produce desired results. The various characteristics mentioned above, as well as other features and characteristics described in more detail below, will be readily apparent to those skilled in the art upon reading the following detailed description of the embodiments, and by referring to the accompanying drawings.

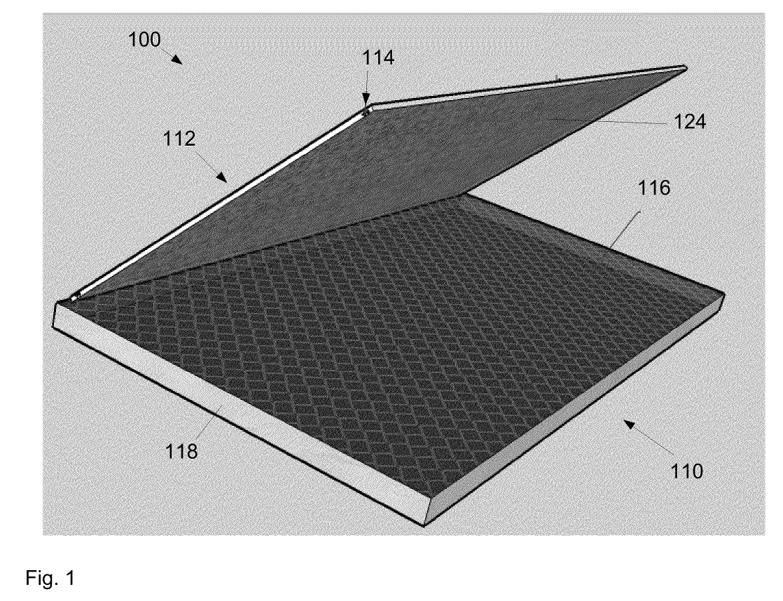

Referring to FIG. 1, a power unit 100 comprises a photovoltaic panel 110, a light guide 112, and an artificial light source 114. A photovoltaic (“PV”) panel 110 comprises one or more PV cells 116, mounted on a support structure 118. The PV panel 110 may be a commercially available unit. The PV cells 116 produce electricity when exposed to light. In an exemplary embodiment, the PV panel 110 is a commercial panel with a rated output of 175 watts (“W”). Multiple PV cells 116 may be present on one panel, each connected to a common power output connection.

An artificial light source 114 provides light for the PV panel 110. In an exemplary embodiment, the artificial light source 114 comprises one or more light emitting diodes (“LED”). Any other electrically powered light source may be used including, for example, incandescent, halogen, fluorescent, a laser, and the like. The artificial light source 114 is attached to the edge or edges of a light guide 112.

The shape of the Power Units 100 is not limited to the shape of a commercially available PV panel 110. The Power Units 100 may have rounded edges, a generally concave shape, or any other external shape, depending on the requirements of the user. A Power Unit 100 could, for example, could be located in a vehicle and thus have a size and shape determined by the size of a compartment on the vehicle.

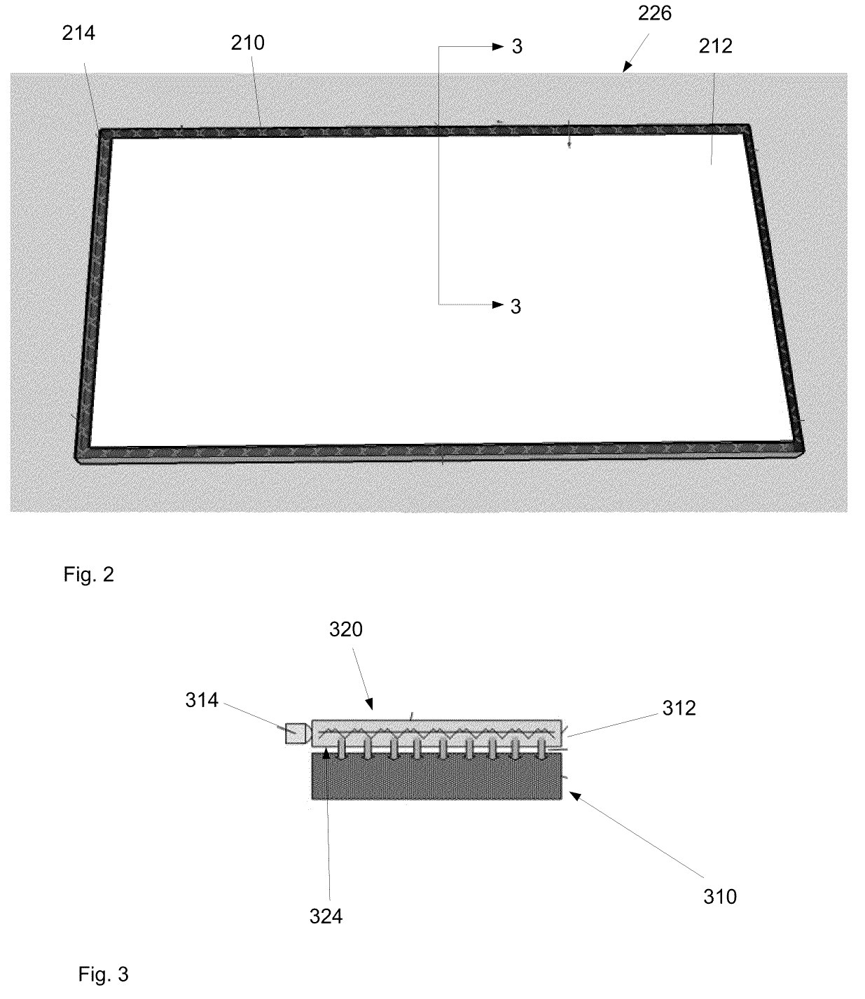

Referring to FIG. 2, in an exemplary embodiment, light emitting diodes (LED) 214 are located along the exterior edge of the optical waveguide (light guide) 212. A light guide 212 is a device that reflects and distributes the light to the photovoltaic panel 210. The height, or thickness, of a light guide may be less than 1″ regardless of the length and width of the light guide. The LEDs 214 beam light into the interior of the light guide 212 where the light is distributed and then focused out through the bottom facing side onto the surface of the photovoltaic panel 210. The amount of light can be varied based on the number of LEDs 214 affixed to the exterior edge of the light guide 212.

The light guide 212 with its LEDs 214 may be attached to the surface of the photovoltaic panel 210 by any means, including bonding, mechanical fasteners, and the like. The light emitting surface 324 (FIG. 3) is in contact or in very close proximity to the PV cells 116 (FIG. 1).

An assembled unit comprising a PV panel 210, lights 214, and a light guide 212 is called a “Power Unit” 226. In an exemplary embodiment, the length, width, and height of the Power Unit 226 is determined by the length and width of a commercially available PV panel 210. In an exemplary embodiment, the Power Unit 226 is approximately 63″ by 31″. The length and width could be larger or smaller depending on the size of the PV panel 210. Furthermore, multiple PV panels 210 could be joined together thus giving the Power Unit 226 a length or width that is larger than a single PV panel 210. The height of the Power Unit 226, comprising the height of the PV panel 210 plus the height of the light guide 212, may be any thickness, including approximately 2″ or 3″. The small overall height is achieved by using the light guide to distribute the light to the PV panel 210. The height could be taller or shorter depending on the thickness of the PV panel 210 and light guide 212.

Referring to FIG. 3, the light guide 312 is a flat panel that reflects the artificial light onto the surface of the PV panel 310. Light emitted by the artificial light source 314 goes into the light guide 320. The light guide 320 reflects and evenly distributes the light through the light emitting surface 324 onto the PV panel 310.

The light guide 312, also referred to as an optical wave guide, is a physical structure that guides electromagnetic waves in the optical spectrum. This device can be utilized as a means for providing illumination over the surface of the PV panel 310. In an exemplary embodiment, the light guide is a piece of glass that is a few millimeters thick, with embedded reflective material. Common types of optical waveguides 312 include optical fiber and rectangular waveguides.

The light guide 312 may have a reflective surface 320 on an exterior surface or edge. In an exemplary embodiment, a single light guide 312 is affixed to a single PV panel 310. The top of the light guide, the side not facing the PV panel 310, may be covered with a reflective coating 320 to direct light back into the light guide and onto the PV panel 310.

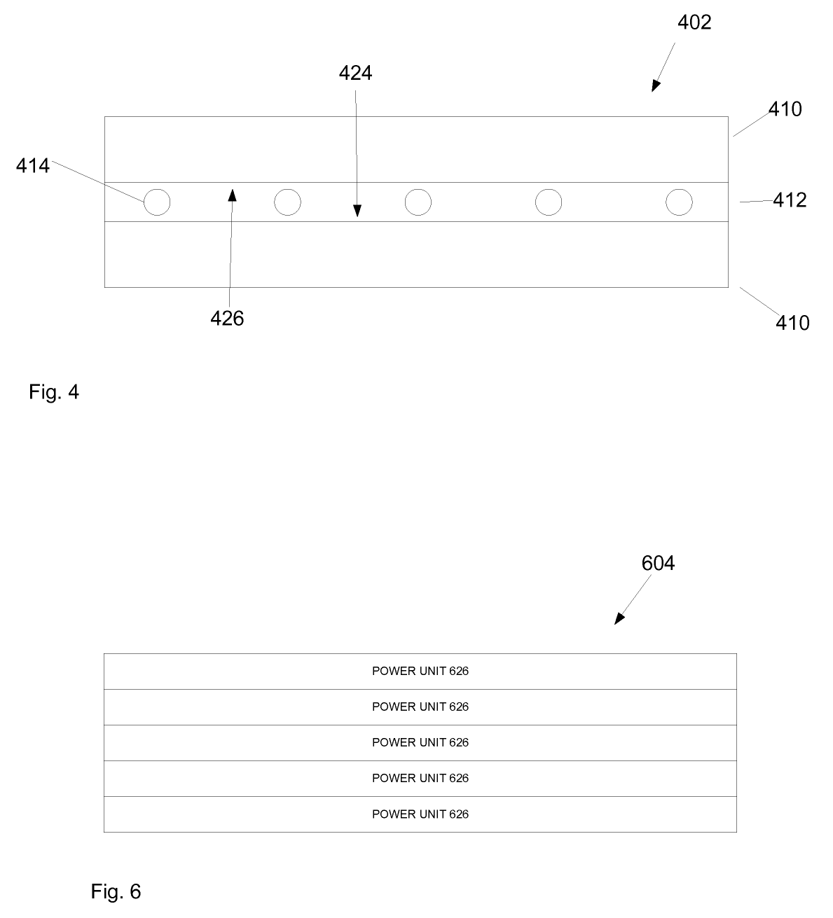

Referring to FIG. 4, in an alternative embodiment, a single light guide 412 illuminates two PV panels 410, forming a dual power unit 402 Two PV panels 410 are attached to the single light guide 412, one on the top and one on the bottom. The light guide 412 emits light from both its top 426 and bottom 424 surfaces. Thus a single set of lights 414 can illuminate two PV panels 410.

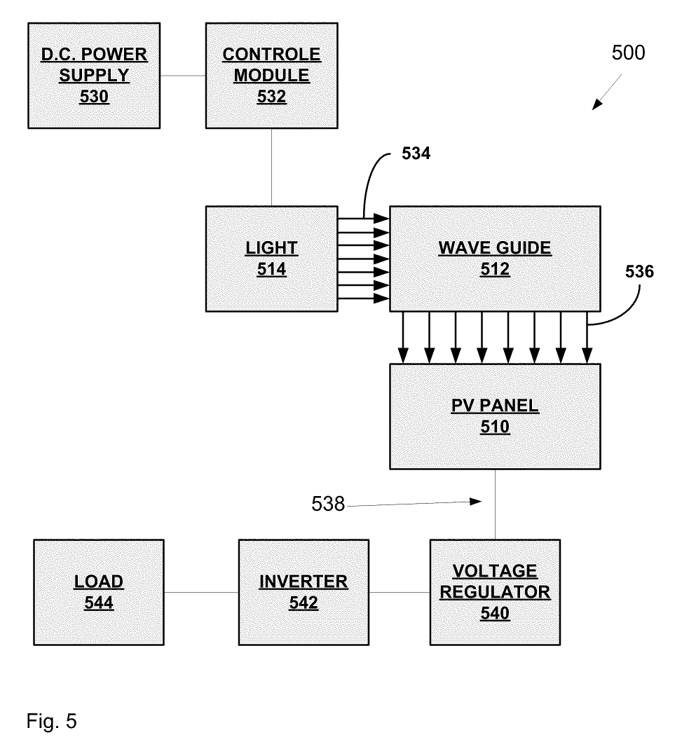

Referring to FIG. 5, in an exemplary embodiment, an external power supply 530 is used to provide the initial power to the artificial light 514. The power supply 530 could be from any direct current (“DC”) power source including, for example, a battery, a wind turbine, alternating current (“AC”) from a power line converted to DC, and the like. The power from the external power supply 530 may go through a control module 532. After the external power supply 530 provides power to the artificial light 514, the light 534 passes through the light guide 512, which reflects the reflected light 536 to the PV panel 510. The light 536 causes the PV panel 510 to produce more power than the artificial lights 514 consume. In an exemplary embodiment, the electricity from the PV panel output 538 is used to power the artificial lights 514, thus making the unit self-powered. A control module 532 or manual control may be used to stop the external power 530 when the Power Unit 500 becomes self powered.

In an exemplary embodiment, the power output 538 from the Power Unit 500 is self limiting based on the brightness of the artificial light source 514. In some embodiments, a voltage regulator 540 may be used to achieve a specific output voltage. The voltage may be higher or lower than the original output 538 voltage of the PV panel. Furthermore, an inverter 542 may be used to convert the Power Unit's 500 DC output to an AC output. The power output ultimately powers an electrical device, or load 544.

Referring to FIG. 6, Multiple Power Units 626 may be combined to form a power unit cluster 604 to increase the total power output 538 (FIG. 5). The Power Units 626 could, for example, be stacked on top of each other or be standing on end adjacent to each other. The electricity from the Power Units 626 may be combined in series to increase voltage, or in parallel to increase amperage, or both.

The output of a PV cell may be increased by exposing it to light having a particular wavelength. A PV cell is typically made of a doped silicon crystal. PV cells have a “band gap,” which is defined as the amount of energy needed to knock an electron loose. The unit of measure for this is electron volts (eV). The band gap varies from one type of PV cell to another, depending on the dopant used in the silicon crystal. The optimal band gap for an exemplary PV cell is typically 1.4 eV.

The optimal wavelength for PV cell performance can be determined as follows:
Assume a band gap of 1.4 eV.
Electromagnetic spectrum eV reference:
   Ultraviolet=3.2-100 eV
   Visible Light=1.6-3.2 eV
   Infrared=1.2 meV-1.7 eV
Electromagnetic spectrum wavelength (λ) reference:
   Visible Light=400-700 nm
   Infrared=700 nm-1 mm
      Near Infrared (“NIR”)=2500-750 nm
      Medium Infrared (“MIR”)=110-2.5 μm
      Far Infrared (“FIR”)=1 mm-110 μm
Electromagnetic spectrum frequency (ν) reference:

Visible Light=400-790 THz
Infrared=300 GHz-400 THz
   NIR=112-400 THz
   MIR=226-112 THz
   FIR=300 GHz−30 THz
Definitions and constants:
   C=speed of light 299,792,458 m/s
   E=energy of photon
   ν=frequency
   E=hν (Planck relation)
   Planck constant: h=6.62609896*110⁻³⁴ J
      S=4.135667*110⁻¹⁵ eVs
   λ=wavelength
   ν=E/h
   λ=C/ν
Calculations: Determining the optimal wave length associated with a photovoltaic cell having a band gap of 1.4 eV.
   ν=1.4 eV/4.13566733*110⁻¹⁵ eVs
   ν=340 THz
   λ=299,792,458/340
   λ=881 nm

Thus the best wavelength of light for a band gap of 1.4 eV is 881 nm, which is located in the Near Infrared (“NIR”) portion of the electromagnetic spectrum. The nearest commercially available light has a wavelength of 880 nm, which is located in the Near Infrared (NIR) portion of the electromagnetic spectrum. The 880 nm light is not visible to the human eye, but still provides power to a PV cell.

When a light source, such as an LED, provides light to a PV cell at the PV cell's optimal wavelength, the PV cell may produce more power than the light source consumes. The following table shows the results from an exemplary experimental embodiment of the photovoltaic panel 110 and artificial light source 114 depicted in FIGS. 1-3.
“Time” indicates the time at which the reading was taken during the test.
“Panel Output(V)” shows voltage output from the PV cell in volts.
“LED Consumption(V)” shows voltage applied to the LEDs in volts.
“Panel Output(A)” shows current produced by the PV cell in amps.
“LED Consumption(A)” shows current consumed by the LEDs in amps.

| | Panel | | Panel | |
|---|---|---|---|---|
| | Output | LED | Output | LED |
| Time | (V) | Consumption (V) | (A) | Consumption (A) |
| 10:00:48 AM | 37.06 | 9.71 | 4.72 | 0.268 |
| 10:01:48 AM | 37.04 | 9.70 | 4.72 | 0.268 |
| 10:02:48 AM | 37.00 | 9.71 | 4.73 | 0.268 |
| 10:03:48 AM | 36.97 | 9.71 | 4.73 | 0.268 |
| 10:04:48 AM | 36.92 | 9.69 | 4.74 | 0.268 |
| 10:05:48 AM | 36.89 | 9.70 | 4.74 | 0.268 |
| 10:06:48 AM | 36.85 | 9.72 | 4.75 | 0.267 |
| 10:07:48 AM | 36.80 | 9.75 | 4.76 | 0.267 |
| 10:08:48 AM | 36.76 | 9.73 | 4.76 | 0.267 |
| 10:09:48 AM | 36.74 | 9.73 | 4.76 | 0.267 |
| 10:10:48 AM | 36.72 | 9.71 | 4.77 | 0.268 |
| 10:11:48 AM | 36.73 | 9.70 | 4.76 | 0.268 |
| 10:12:48 AM | 36.71 | 9.71 | 4.77 | 0.268 |
| 10:13:48 AM | 36.68 | 9.72 | 4.77 | 0.267 |
| 10:14:48 AM | 36.66 | 9.68 | 4.77 | 0.269 |
| 10:15:48 AM | 36.60 | 9.67 | 4.78 | 0.269 |
| 10:16:48 AM | 36.58 | 9.67 | 4.78 | 0.269 |
| 10:17:48 AM | 36.50 | 9.70 | 4.79 | 0.268 |
| 10:18:48 AM | 36.42 | 9.64 | 4.81 | 0.270 |
| 10:19:48 AM | 36.38 | 9.65 | 4.81 | 0.269 |
| 10:20:48 AM | 36.30 | 9.64 | 4.82 | 0.270 |
| 10:21:48 AM | 36.27 | 9.64 | 4.82 | 0.270 |
| 10:22:48 AM | 36.21 | 9.61 | 4.83 | 0.271 |
| 10:23:48 AM | 36.20 | 9.57 | 4.83 | 0.272 |
| 10:24:48 AM | 36.18 | 9.60 | 4.84 | 0.271 |
| 10:25:48 AM | 36.18 | 9.59 | 4.84 | 0.271 |
| 10:26:48 AM | 36.20 | 9.59 | 4.83 | 0.271 |
| 10:27:48 AM | 36.21 | 9.59 | 4.83 | 0.271 |
| 10:28:48 AM | 36.17 | 9.60 | 4.84 | 0.271 |
| 10:29:48 AM | 36.09 | 9.60 | 4.85 | 0.271 |
| 10:30:48 AM | 36.24 | 9.61 | 4.83 | 0.271 |
| 10:31:48 AM | 36.27 | 9.60 | 4.82 | 0.271 |
| 10:32:48 AM | 36.26 | 9.60 | 4.83 | 0.271 |
| 10:33:48 AM | 36.26 | 9.63 | 4.83 | 0.270 |
| 10:34:48 AM | 36.26 | 9.62 | 4.83 | 0.270 |
| 10:35:48 AM | 36.28 | 9.61 | 4.82 | 0.271 |
| 10:36:48 AM | 36.31 | 9.62 | 4.82 | 0.270 |
| 10:37:48 AM | 36.30 | 9.59 | 4.82 | 0.271 |
| 10:38:48 AM | 36.34 | 9.60 | 4.82 | 0.271 |
| 10:39:48 AM | 36.32 | 9.61 | 4.82 | 0.271 |
| 10:40:48 AM | 36.38 | 9.59 | 4.81 | 0.271 |
| 10:41:48 AM | 36.36 | 9.59 | 4.81 | 0.271 |
| 10:42:48 AM | 36.39 | 9.61 | 4.81 | 0.271 |
| 10:43:48 AM | 36.43 | 9.60 | 4.80 | 0.271 |
| 10:44:48 AM | 36.45 | 9.60 | 4.80 | 0.271 |
| 10:45:48 AM | 36.43 | 9.63 | 4.80 | 0.270 |
| 10:46:48 AM | 36.45 | 9.60 | 4.80 | 0.271 |
| 10:47:48 AM | 36.46 | 9.60 | 4.80 | 0.271 |
| 10:48:48 AM | 36.46 | 9.60 | 4.80 | 0.271 |
| 10:49:48 AM | 36.45 | 9.60 | 4.80 | 0.271 |
| 10:50:48 AM | 36.49 | 9.60 | 4.80 | 0.271 |
| 10:51:48 AM | 36.49 | 9.59 | 4.80 | 0.271 |
| 10:52:48 AM | 36.51 | 9.60 | 4.79 | 0.271 |
| 10:53:48 AM | 36.53 | 9.58 | 4.79 | 0.271 |
| 10:54:48 AM | 36.54 | 9.58 | 4.79 | 0.271 |
| 10:55:48 AM | 36.57 | 9.58 | 4.79 | 0.271 |
| 10:56:48 AM | 36.62 | 9.57 | 4.78 | 0.272 |
| 10:57:48 AM | 36.60 | 9.57 | 4.78 | 0.272 |
| 10:58:48 AM | 36.59 | 9.57 | 4.78 | 0.272 |
| 10:59:48 AM | 36.60 | 9.58 | 4.78 | 0.271 |
| 11:00:48 AM | 36.64 | 9.56 | 4.78 | 0.272 |

The table shows that the PV panel in the exemplary experimental embodiment produced a higher voltage and amperage, and thus more power, than the LEDs consumed.

It is understood that variations may be made in the above without departing from the scope of the invention. While specific embodiments have been shown and described, modifications can be made by one skilled in the art without departing from the spirit or teaching of this invention. The embodiments as described are exemplary only and are not limiting. One or more elements of the exemplary embodiments may be combined, in whole or in part, with one or more elements of one or more of the other exemplary embodiments. Many variations and modifications are possible and are within the scope of the invention. Accordingly, the scope of protection is not limited to the embodiments described, but is only limited by the claims that follow, the scope of which shall include all equivalents of the subject matter of the claims.

I claim:

1. An apparatus for producing electricity, the apparatus comprising:
a photovoltaic panel comprising at least one photovoltaic cell having an associated optimal wave length,
an artificial light source producing a light having the optimal wave length,
a light guide having a first surface, a second surface, and an edge,
wherein the light guide is attached to the photovoltaic panel and wherein the first surface of the light guide is proximate to the at least on photovoltaic cell, and
wherein the artificial light emits the light into the light guide and the light guide directs the light to the photovoltaic cell.

2. The apparatus of claim 1, wherein the artificial light source is attached to the edge of the light guide and wherein the light is emitted from the first surface of the light guide.

3. The apparatus of claim 2, wherein the length of the apparatus is greater than ten times the thickness of the apparatus.

4. The apparatus of claim 1, wherein the artificial light source is a light emitting diode.

5. The apparatus of claim 1, further comprising an external power supply, wherein the external power supply provides electricity to the artificial light source.

6. The apparatus of claim 5, wherein the external power supply is a battery.

7. The apparatus of claim 1 wherein a power output from the photovoltaic panel exceeds a power applied to the artificial light source.

8. The apparatus of claim 1 further comprising a second photovoltaic panel, wherein the second photovoltaic panel is proximately located with the second surface of the light guide.

9. An apparatus for generating electricity, the apparatus comprising:
a photovoltaic panel comprising a photovoltaic cell having an associated optimal wavelength,
a plurality of light emitting diodes attached to a light guide, wherein the light emitting diodes produce a light having the optimal wavelength, wherein
the light guide is attached to the photovoltaic panel,
the light guide directs light from the plurality of light emitting diodes to the photovoltaic cell, and
an external power supply providing an external power to the plurality of light emitting diodes, wherein the power produced by the photovoltaic panel is greater than the power produced by the external power supply.

10. The apparatus of claim 9, further comprising an inverter, wherein the inverter transforms a portion the power produced by the photovoltaic panel into alternating-current electricity.

11. The apparatus of claim 9, wherein there is no gap between the light guide and the photovoltaic panel.

12. The apparatus of claim 9, wherein the largest linear dimension of the apparatus is more than ten times the smallest linear dimension.

13. The apparatus of claim 9, further comprising a second photovoltaic panel, wherein the light guide is located between the photovoltaic panels.

14. The apparatus of claim 9, further comprising
a circuit, wherein the circuit transfers electricity from the photovoltaic panel to the plurality of light emitting diodes, and
a control module, wherein the control module stops the power from the external power source when the electricity from the photovoltaic panel is sufficient to power the light emitting diodes.

15. A method for providing electricity, the method comprising:
creating a power unit comprising an artificial light source, a light guide, and a photovoltaic panel, wherein the artificial light source is attached to the light guide and wherein the light guide is attached to the photovoltaic panel,
providing an initial electrical current to the artificial light source,
directing a light output from the artificial light source through the light guide to the photovoltaic panel, causing the photovoltaic panel to produce an output electrical current,
using a portion of the output electrical current to provide power to the artificial light source, and
removing the initial electrical current from the artificial light source after the output electrical current exceeds the initial electrical current.

16. The method of claim 15, further comprising a second voltaic panel, wherein the light guide directs light to the voltaic panel and the second voltaic panel.

17. The method of claim 15, wherein the artificial light source is a light emitting diode.

18. The method of claim 15, wherein the combined height of the photovoltaic panel and the light guide is less than three inches.

19. The method of claim 15, further comprising a plurality of power units, wherein the output electrical current from the plurality of power units is combined.

20. The method of claim 15, wherein the photovoltaic panel has an associated optimal wavelength, and wherein the light output from the artificial light source matches the optimal wavelength.

21. A method for producing electricity comprising:
attaching a light guide to a photovoltaic panel;
using the light guide to direct light from an infrared light source to the photovoltaic panel, causing the photovoltaic panel to produce an electric current;
conducting a first portion of the electric current to the infrared light source, wherein the first portion of the electric current is sufficient to power the infrared light source; and
conducting a second portion of the electric current to a load.

22. The method of claim 21, further comprising:
using the light guide to direct light from the infrared light source to a second photovoltaic panel.

23. The method of claim 21, wherein the light guide comprises a piece of glass having embedded reflective material.

24. The method of claim 21, wherein the infrared light source comprises a light emitting diode.

25. The method of claim 21, wherein the light guide and the photovoltaic panel have a combined thickness of less than three inches.

26. The method of claim 21, further comprising attaching the light guide and photovoltaic panel to a second photovoltaic panel, the second photovoltaic panel being attached to a second light guide.
